(19) United States
(12) Patent Application Publication
(10) Pub. No.: US 2003/0067445 A1
(43) Pub. Date: Apr. 10, 2003

(54) Remote keypad

(75) Inventors: David Hirshberg, Haifa (IL); Gideon Ashkenazi, Raanana (IL)

Correspondence Address: DR. MARK FRIEDMAN LTD., c/o BILL POLKINGHORN, DISCOVERY DISPATCH, 9003 FLORIN WAY, UPPER MARLBORO, MD, 20772, US

(73) Assignee: JetWay Technologies Ltd

(21) Appl. No.: 10/272,999

(22) Filed: Oct. 18, 2002

Related U.S. Application Data
(63) Continuation-in-part of application No. 09/985,596, filed on Nov. 5, 2001.
Application No. 09/985,596 is a continuation-in-part of application No. 09/518,634, filed on Mar. 3, 2000, now abandoned.

(51) Int. Cl. G09G 5/00

(52) U.S. Cl. 345/168

(57) ABSTRACT

A system comprising a processor and an input device. The input device has a first communication port disposed thereon. The first communication port is configured to wirelessly communicate keystrokes performed on the input device to the processor. The input device is configured for being held and operated with one hand. The input device has a complete basic alphanumeric character set and a plurality of symbols which are actuated by one of at least ten multifunction keys arranged in a grid of three columns by four rows, each of the multifunction keys being configured for single-touch selection of exactly four functions depending on a direction of force thereon. The input device has at least three control keys, each of the control keys being configured to perform a function in conjunction with at least one other key.

This application is a is a continuation-in-part of co-pending U.S. application Ser. No. 09/985,596 filed on Nov. 5, 2001, which is in itself a continuation-in-part of U.S. application Ser. No. 09/518,634 filed on Mar. 3, 2000.

### FIELD AND BACKGROUND OF THE INVENTION

The present invention relates to a input device and, in particular, it concerns a wireless handheld input device with multiple function keys.

Increasingly, higher-density integrated circuits enable computers and other electronic devices to be continually reduced in size. Although, conventional data entry devices such as keys and keyboards can be scaled down in physical dimensions, a high practical limit to such reduction is imposed by their design and construction. For customary, alphanumeric data entry in addition to the 10 numerals and the 26 letters of the alphabet there also needs to be other symbols and functions keys. The use of much smaller keys to significantly reduce the size of a conventional keyboard would only make the keyboard difficult to use and error-prone. This problem represents a major obstacle to continued miniaturization of electronic devices that use keyboards.

Of most relevance to the present invention are U.S. Pat. No. 5,528,235 to Lin et al., U.S. Pat. No. 5,861,823 to Strauch et al, U.S. Pat. No. 4,029,915 to Ojima, U.S. Pat. No. 4,896,003 to Hsich and U.S. Pat. No. 6,157,323 to Tso et al. These patents teach a multifunction key that enables a plurality of functions for example digits or letters to be typed by a single touch depression of the multifunction key in different orientations without the use of a shift or other key. Therefore, keyboards can be miniaturized while maintaining an acceptable key-size. A problem with multifunction keys is that input errors can occur when the multifunction key is depressed in an orientation, which is between the desired orientations. This problem is partially addressed by Strauch et al. and Tso et al. whereby if a multifunction key is depressed in an orientation, which is between the desired directions, only one of the functions can be activated. However, both Strauch et al. and Tso et al. do not address the problem of a discouraging a user from depressing the multifunction key in an orientation, which is between the desired orientations.

Therefore, there is a need for a multifunction key structure, which discourages or prevents a user from depressing the multifunction key in an orientation, which is between the desired orientations.

Another problem with miniaturizing a keyboard is to have a layout, which is intuitive and user friendly. In Lin et al., multifunction keys having digits and letters are arranged in the form of a telephone keypad. A shortcoming of the aforementioned system is due to having five functions per key making the system prone to input errors.

Therefore, there is a need for a keyboard layout, which is in the form of a telephone keypad that has a maximum of four functions per key.

A miniaturized keyboard is typically suited for a user to hold in his or her hand instead of resting the keyboard on a surface. In such a case, a conventionally cable between a keyboard and computer or other system can be cumbersome and limiting to the movements of the user. Additionally, a user typically wants to have a mouse or joystick control near the keyboard. Moreover, the user typically wants to be able to hold and operate the keyboard with the same hand.

Therefore, there is a need for a wireless input device incorporating a mouse that can be held and operated with the same hand.

### SUMMARY OF THE INVENTION

The present invention is a wireless handheld input device with multiple function keys construction and method of operation thereof.

According to the teachings of the present invention there is provided, a system comprising a processor and an input device, wherein: (a) said input device has a first communication port disposed thereon, said first communication port being configured to wirelessly communicate keystrokes performed on said input device to said processor; (b) said input device is configured for being held and operated with one hand; (c) said input device has a plurality of keypads, one of said keypads being a primary keypad located centrally on said input device, said primary keypad having a complete basic alphanumeric character set and a plurality of symbols, said primary keypad having at least ten multifunction keys arranged in a grid of three columns by four rows, each of said multifunction keys being configured for single-touch selection of exactly four functions depending on a direction of force thereon, one of said four functions being uniquely selected from group consisting of a digit in the range of 0 to 9 and a “*” symbol and a “#” symbol at least one of said symbols is uniquely associated with each of said multifunction keys; said primary keypad being visually distinguished from other of said keypads by at least one of a key shape, a key color, a key labeling font, a key labeling color and a key labeling font size; and (d) said input device has a secondary keypad including at least three control keys, each of said control keys being configured to perform a function in conjunction with at least one other key, one of said control keys being a shift control key configured to select a capital letter from said primary keypad, one of said control keys being a symbol control key configured to select one of said symbols from said primary keypad.

According to a further feature of the present invention said secondary keypad includes a row of keys including a character insertion function key, an enter function key and a backspace function key.

According to a further feature of the present invention said control keys include an auxiliary control key configured to perform a plurality of Windows OS functions and a plurality of multimedia extension functions in conjunction with said primary keypad.

According to a further feature of the present invention said control keys include a macro key configured to allows a user to program and activate a sequence of keystrokes that are used frequently by a user.

According to a further feature of the present invention said input device includes a volume control key, a channel selection key, at least one interactive television navigator key, at least one device selection key and at least one Internet service key.

According to a further feature of the present invention said input device includes at least one quick application launcher key.

According to a further feature of the present invention said input device includes at least one of a pointing device and a joystick control.

According to a further feature of the present invention: (a) said input device has a casing which has a top surface and a bottom surface; (b) said top surface has a long dimensions a width measurement perpendicular to said long dimension and a central region; (c) said width measurement has a local minimum value within said central region; and (d) said bottom surface has a convex portion.

According to a further feature of the present invention, there is also provided a base unit having a second communication port wherein: (a) said base unit is connected to said processor; (b) said first communication port and said second communication port define a wireless communication link: and (c) at least one of said input device and said base unit are configured to wirelessly communicate keystrokes performed on said input device via said wireless communication link to said processor.

According to a further feature of the present invention said wireless communication link is an infrared communication link.

According to a further feature of the present invention said control keys are disposed near a periphery of said input device.

According to a further feature of the present invention at least one of said multifunction keys includes: (a) a key body; (b) a set of at least three make-and-break contacts disposed below said key body; said key body being titled in a plurality of primary angular directions in order to selectively actuate only one of said set; and (c) a resisting arrangement configured to provide a greater resistance to a user tilting said key body in one of a plurality of secondary angular directions compared to said user tilting said key body in one of said primary angular directions.

According to a further feature of the present invention: (a) said key body has a lower side; (b) said resisting arrangement includes an elongated element having a first end and a second end, said first end being disposed on said lower side; and (c) said resisting arrangement includes a lifting member which is disposed on said second end, said lifting member projecting laterally from said elongated element.

According to a further feature of the present invention said resisting arrangement includes at least three flaps, wherein said flaps are disposed on said lifting member and are resiliently supported, such that, when said user tilts said key body in one of said secondary angular directions, a greater resistance is provided by said flaps against said lifting member than when said user tilts said key body in one of said primary angular directions.

According to a further feature of the present invention at least one of said flaps has a bottom surface, said bottom surface including a convex portion.

According to a further feature of the present invention said resisting arrangement includes at least three flaps wherein said flaps are disposed oil said lifting member and are resiliently supported, such that, when said user tilts said key body in one of said secondary angular directions, said lifting member lifts at least two of said flaps, and when said user tilts said key body in one of said primary angular directions, said lifting member only lifts one of said flaps substantially.

According to a further feature of the present invention at least one of said flaps has a bottom surface, said bottom surface including a convex portion.

According to a further feature of the present invention said key body and said elongated element are formed as a unitary member.

According to a further feature of the present invention said elongated element and said lifting member are formed as a unitary member.

According to a further feature of the present invention said resisting arrangement includes a resilient support structure, which is configured to at least partially support said key body, such that, when said user tilts said key body in one of said secondary angular directions, a greater resistance is provided by said resilient support structure against said key body than when said user tilts said key body in one of said primary angular directions.

According to a further feature of the present invention at least one of said multifunction keys includes: (a) a key body having a lower side; (b) a set of at least three make-and-break contacts disposed below said key body; said key body being titled in a plurality of primary angular directions in order to selectively actuate only one of said set; (c) an elongated element having a first end and a second end, said first end being disposed on said lower side; and (d) a template which is rigidly supported, said template being formed, such that, when a user tilts said key body in one of a plurality of secondary angular directions, a greater inhibition is provided by said template against said elongated element than when said user tilts said key body in one of said primary angular directions.

According to a further feature of the present invention at least one of said input device and said processor is configured such that: (a) when one of said control keys is depressed and released, a next key stroke is assumed, for at least a period of time, to be in conjunction with said one control key that was previously released; and (b) a first key that is depressed while said one control key is depressed is assumed to be in conjunction with said one control key; and (c) after a release of said one control key and said first key, a depression of a second key is assumed to be a start of a new keystroke.

According to a further feature of the present invention at least one of said input device and said processor is further configured such that when said one control key is depressed and released and within at least a period of time, said one control key is depressed and released again, a control lock function is set for said one control key.

According to a further feature of the present invention at least one of said input device and said processor is configured such that, when one of said control keys is depressed and released and within at least a period of time, said one control key is depressed and released again, a control lock function is set for said one control key.

According to a further feature of the present invention at least one of said input device and said processor is further configured such that, said control lock function is released when said one control key is subsequently one of, depressed and depressed and released.

According to a further feature of the present invention: (a) for each of eight of said ten multifunction keys, one of said four functions is uniquely associated with a digit in the range 2 to 9; (b) for each of said eight multifunction keys, each of three of said four functions is uniquely associated with a letter; and (c) for one of said ten multifunction keys, one of said four functions is associated with a digit zero, one of said four functions is associated with a letter from a group consisting of a letter ‘P’ and a letter ‘Q’ and a letter ‘R’ and a letter ‘S’, one of said four functions is associated with a letter from a group consisting of a letter ‘W’ and a letter ‘X’ and a letter ‘Y’ and a letter ‘Z’.

According to a further feature of the present invention: (a) for each of eight of said ten multifunction keys, one of said four functions is uniquely associated with a digit in the range 2 to 9; (b) for each of said eight multifunction keys, each of three of said four functions is uniquely associated with a letter; (c) for one of said ten multifunction keys, one of said four functions is associated with a symbol “*”, one of said four functions is associated with a letter from a group consisting of a letter ‘P’ and a letter ‘Q’ and a letter ‘R’ and a letter ‘S’; and (d) for one of said ten multifunction keys, one of said four functions is associated with a symbol “#”, one of said four functions is associated with a letter from a group consisting of a letter ‘W’ and a letter ‘X’ and a letter ‘Y’ and a letter ‘Z’.

According to the teachings of the present invention there is also provided a multifunction key, comprising: (a) a key body; (b) a set of at least three make-and-break contacts disposed below said key body; said key body being titled in a plurality of primary angular directions in order to selectively actuate only one of said set; and (c) a resisting arrangement configured to provide a greater resistance to a user tilting said key body in one of a plurality of secondary angular directions compared to said user tilting said key body in one of said primary angular directions.

According to a further feature of the present invention: (a) said key body has a lower side; (b) said resisting arrangement includes an elongated element having a first end and a second end, said first end being disposed on said lower side; and (c) said resisting arrangement includes a lifting member which is disposed on said second end, said lifting member projecting laterally from said elongated element.

According to a further feature of the present invention said resisting arrangement includes at least three flaps, wherein said flaps are disposed on said lifting member and are resiliently supported, such that, when said user tilts said key body in one of said secondary angular directions, a greater resistance is provided by said flaps against said lifting member than when said user tilts said key body in one of said primary angular directions.

According to a further feature of the present invention at least one of said flaps has a bottom surface, said bottom surface including a convex portion.

According to a further feature of the present invention said resisting arrangement includes at least three flaps, wherein said flaps are disposed on said lifting member and are resiliently supported, such that, when said user tilts said key body in one of said secondary angular directions, said lifting member lifts at least two of said flaps, and when said user tilts said key body in one of said primary angular directions, said lifting member only lifts one of said flaps substantially.

According to a further feature of the present invention at least one of said flaps has a bottom surface, said bottom surface including a convex portion.

According to a further feature of the present invention said key body and said elongated element are formed as a unitary member.

According to a further feature of the present invention said elongated element and said lifting member are formed as a unitary member.

According to a further feature of the present invention said resisting arrangement includes a resilient support structure, which is configured to at least partially support said key body, such that, when said user tilts said key body in one of said secondary angular directions, a greater resistance is provided by said resilient support structure against said key body than when said user tilts said key body in one of said primary angular directions.

According to the teachings of the present invention there is also provided a multifunction key, comprising: (a) a key body having a lower side; (b) at set of at least three make-and-break contacts disposed below said key body; said key body being titled in a plurality of primary angular directions in order to selectively actuate only one of said set; (c) an elongated element having a first end and a second end, said first end being disposed on said lower side; and (d) a template which is rigidly supported, said template being formed, such that, when a user tilts said key body in one of a plurality of secondary angular directions, a greater inhibition is provided by said template against said elongated element than when said user tilts said key body in one of said primary angular directions.

According to the teachings of the present invention there is also provided a system, comprising: (a) a processor; and (b) a input device having a plurality of keys, said input device being associated with said processor, at least one of said keys being a control key, at least one of said input device and said processor being configured such that: (i) when said control key is depressed and released, a next keystroke is assumed, for at least a period of time, to be in conjunction with said control key that was previously released; (ii) a first key that is depressed while said control key is depressed is assumed to be in conjunction with said control key; and (iii) after a release of said control key and said first key, a depression of a second key is assumed to be a start of a new keystroke.

According to a further feature of the present invention at least one of said input device and said processor is further configured such that when said control key is depressed and released and within at least a period of time, said control key is depressed and released again, a control lock function is set for said control key.

According to a further feature of the present invention: (a) said input device is configured for being held and operated with one hand; and (b) said control key is disposed near a periphery of said input device.

According to the teachings of the present invention there is also provided a system, comprising: (a) a processor; and (b) a input device having a plurality of keys, said input device being associated with said processor, at least one of said keys being a control key, at least one of said input device and said processor being configured such that when said control key is depressed and released and within at least a period of time, said control key is depressed and released again, a control lock function is set for said control key.

According to a further feature of the present invention at least one of said input device and said processor is further configured such that, said control lock function is released when said control key is subsequently one of, depressed and depressed and released.

According to a further feature of the present invention: (a) said input device is configured for being held and operated with one hand; and (b) said control key is disposed near a periphery of said input device.

According to the teachings of the present invention there is also provided a input device comprising: (a) at least eight multifunction keys, each of said multifunction keys being configured for single-touch selection of one of four functions, one of said four functions being uniquely associated with a digit in the range 2 to 9, each of three of said four functions being uniquely associated with a letter; and (b) a multifunction key configured for single-touch selection of one of at least three functions, wherein: (i) one of said at least three functions is associated with a digit zero; (ii) one of said at least three functions is associated with a letter from a group consisting of a letter ‘P’ and a letter ‘Q’ and a letter ‘R’ and a letter ‘S’; and (iii) one of said at least three functions is associated with a letter from a group consisting of a letter ‘W’ and a letter ‘X’ and a letter ‘Y’ and a letter ‘Z’.

According to the teachings of the present invention there is also provided an input device comprising: (a) at least eight multifunction keys, each of said multifunction keys being configured for single-touch selection of one of four functions, one of said four functions being uniquely associated with a digit in the range 2 to 9, each of three of said four functions being uniquely associated with a letter; (b) a multifunction key configured for single-touch selection of one of at least two functions, wherein: (i) one of said at least two functions is associated with a symbol ‘*’; and (ii) one of said at least two functions is associated with a letter from a group consisting of a letter ‘P’ and a letter ‘Q’ and a letter ‘R’ and a letter ‘S’; and (b) a multifunction key configured for single-touch selection of one of at least two functions, wherein: (i) one of said at least two functions is associated with a symbol ‘#’; and (ii) one of said at least two functions is associated with a letter from a group consisting of a letter ‘W’ and a letter ‘X’ and letter ‘Y’ and a letter ‘Z’.

### BRIEF DESCRIPTION OF THE DRAWINGS

The invention is herein described, by way of example only, with reference to the accompanying drawings, wherein:

FIG. 1 is an isometric view of a input device arrangement that is constructed and operable in accordance with a preferred embodiment of the invention;

FIG. 2 is a front view of a computer input device of the input device arrangement of FIG. 1;

FIG. 3a is a front view of an interactive television input device of the input device arrangement of FIG. 1;

FIG. 3b is a front view of an alternate embodiment of an interactive television input device of the input device arrangement of FIG. 1;

FIG. 4 is a flow chart shoving a control key logic of control keys of the input device arrangement of FIG. 1;

FIG. 5a is a schematic plan view of a multifunction key having a resisting arrangement of the input device arrangement of FIG. 1;

FIG. 5b is a graph showing the behavior of the resisting arrangement of the multifunction key of FIG. 5a;

FIG. 6 is a cross-sectional view of a multifunction key, having a resisting arrangement, of the input device arrangement of FIG. 1;

FIG. 7 is a cross-sectional view taken along line A-A of FIG. 6;

FIG. 8 is a cross-sectional view taken along line B-B of FIG. 6;

FIG. 9 is a graph showing the relationship between the activity regions of the make-and-break contacts and the angular directions of tilt of a multifunction key of the input device arrangement of FIG. 1;

FIG. 10 is a plan view of a template formed within a circuit board of a multifunction key of the input device arrangement of FIG. 1;

FIG. 11 is a cross-sectional view of a multifunction key, having an alternate resisting arrangement, of the input device arrangement of FIG. 1;

FIG. 12 is a cross-sectional view taken along line B-B of FIG. 11 and

FIG. 13 is a centralization mechanism for use with the multifunction key of FIG. 11.

### DESCRIPTION OF THE PREFERRED EMBODIMENTS

The present invention is a wireless handheld input device arrangement with multiple function keys construction and method of operation thereof.

The principles and operation of the wireless handheld input device according to the present invention may be better understood with reference to the drawings and the accompanying description.

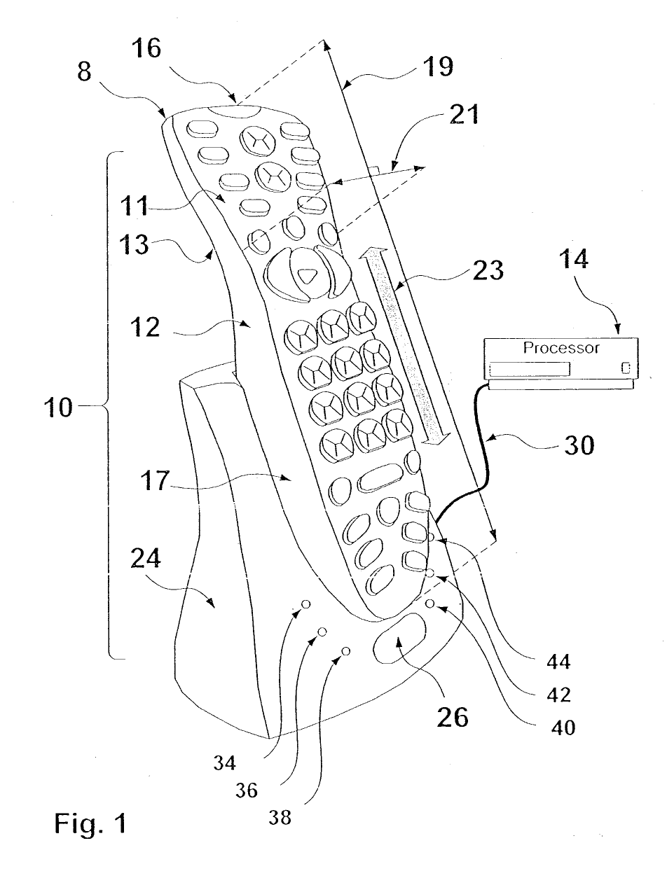

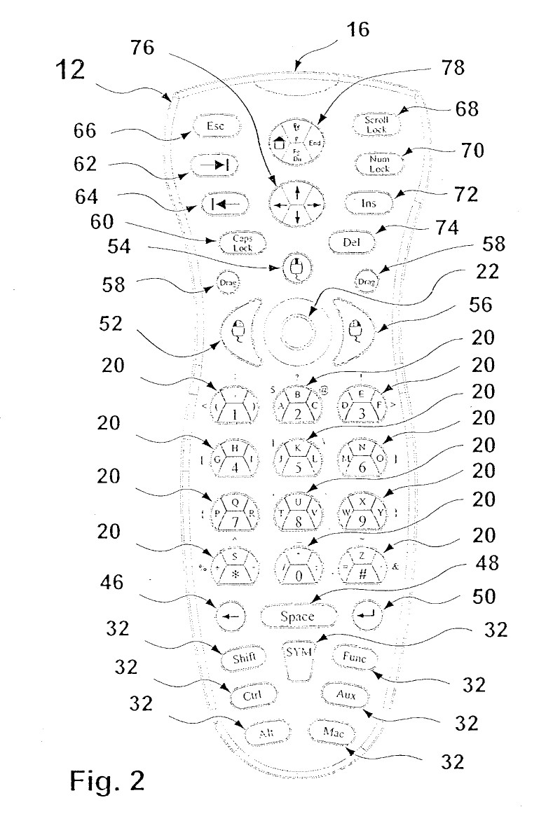

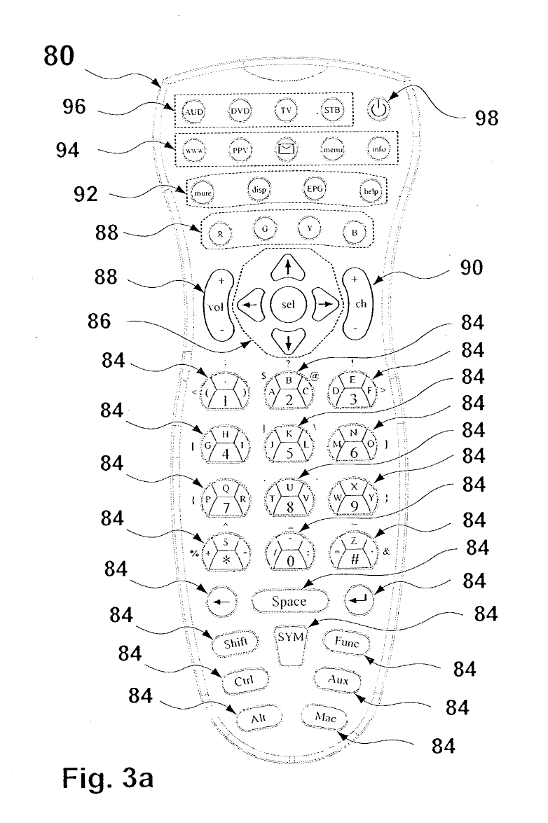

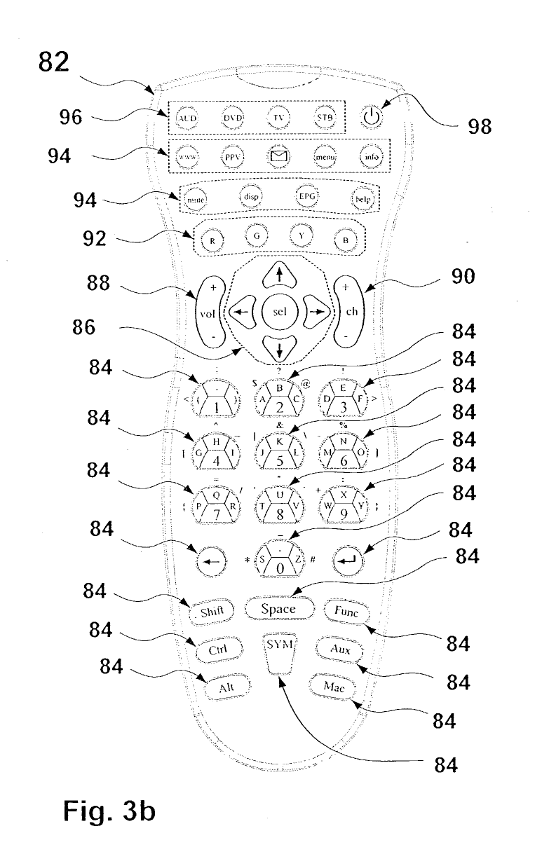

Reference is now made to FIG. 1 and FIG. 2. FIG. 1 is an isometric view of an input device arrangement 10 that is constructed and operable in accordance with a preferred embodiment of the invention. FIG. 2 is a front view of an input device 12 of input device arrangement 10. Input device has a casing 8 which has a top surface 11 and a bottom surface 13. Top surface 11 has a long dimension 19, a width measurement 21 perpendicular to long dimension 19 and a central region 23. Central region 23 does not include the regions of top surface 11 where top surface 11 tapers towards the top and bottom of top surface 11. Input device 12 is configured for being held and operated with one hand. Therefore, width measurement 21 has a local minimum value within central region 23, to increase the ease of one handed operation by a user of input device 12. The narrowing of top surface 11 is preferably to no more than about 80%, and preferably about 70%, of the maximum width of top surface 11. Additionally, bottom surface 13 has a convex portion 17 to increase the ease of one-handed operation by a user of input device 12. Input device arrangement 10 is configured for inputting keystrokes to a processor 14. Input device 12 has a primary keypad which includes a plurality of multifunction keys 20. The primary keypad is centrally located on input device 12 in that when input device 12 is held in it's natural holding position the user's thumb will rest near the center of the primary keypad. The primary keypad has complete basic alphanumeric character set, having a full alphabet of an appropriate language alphabet and digits 0 to 9 and a plurality of symbols. The complete basic alphanumeric character set and the symbols are actuated using a plurality of multifunction keys 20. Eight of multifunction keys 20 are each associated with a digit in the range 2 to 9 and three letters of the alphabet, thereby accommodating 24 letters of the alphabet among these eight multifunction keys. The allocation of the remainder of the alphabet is discussed below with reference to FIGS. 3a and 3b. The layout, labeling and character assignment of the complete basic alphanumeric character on multifunction keys 20 are based on a standard telephone keypad whereby multifunction keys 20 are generally arranged in a grid of three columns by four rows. It should be noted that in some embodiments of the present invention the grid is not completely filled with multifunction keys 20. Each of multifunction keys 20 is configured for single-touch selection of one of four functions depending on a direction of force thereon. For example, one of multifunction keys 20 having the digit 2 is configured to perform a function associated with the letter A when tilted to the left, letter B when tilted up, letter C when tilted right and digit 2 when tilted down. The primary keypad is visually distinguished from the other keypads of input device 12 by at least one of the key shape, key color, key-labeling font, key labeling color and key labeling font size. Input device 12 also includes a pointing device 22 or a joystick control. Pointing device 22 is typically a mouse, trackball, touch-pad or other known apparatus for performing a pointing function. In accordance with a most preferred embodiment of the invention, pointing device 22 is a rubber cone which acts as s stick-based mouse that navigates a cursor according to a direction of a force activated on pointing device 22. A key 52 performs the function of a left click of a standard PC mouse. A key 54 performs the function of a middle click of a standard PC mouse. A key 56 performs the function of a right click of a standard PC mouse. Two keys 58 perform a drag operation of a standard PC mouse.

As described above, input device 12 is configured for being held and operated with one hand. Therefore, input device 12 includes a secondary keypad which includes a plurality of control keys 32, which are disposed near a periphery of input device 12. Near a periphery means that control keys 32 are within easy reach of the user. In a most preferred embodiment of the present, invention control keys 32 are positioned toward the lower section of input device 12. In accordance with a preferred embodiment of the present invention, control keys 32 are positioned on a side of input device 12. Control keys 32 are defined as keys which perform a function in conjunction with at least one other key. Control keys 32 include a Shift function key for selecting a capital letter from the primary keypad, a Control (Ctrl) function key and an Alt function key. Control keys 32 also include a symbol (SYM) function key, which allows a user to select a full set of symbols, which are typically available in a standard PC keyboard, from the primary keypad. The available symbols are shown surrounding each of multifunction keys 20. A symbol is selected by pressing the symbol function key with one of multifunction keys 20 which is tilted in the direction of the desired symbol. Control keys 32 also include a Function (Func) control key, which allows a user to select the 12 function keys, F1-F12, of standard PC keyboard. For example, in order to activate F1 a user presses the Func key and then presses the ‘1’ key. The F1 to F9 function keys are selected by using multifunction keys 20 having digits ‘1’ to ‘9’. F10 is selected using digit 0. F11 and F12 are selected using ‘*’ and ‘#’ respectively. Control keys 32 also include an auxiliary (AUX) key which allows a user to activate an auxiliary set of functions. The auxiliary set of functions typically includes special windows OS functions and multimedia extension functions such as volume control, power management keys such as sleep and wake, quick application launcher keys such as web browser, mail composer and calculator. For example, pressing the AUX key with ‘S’ activates a window start function, while pressing the AUX key with ‘C’ activates a window calculator application. Control keys 32 also include a MAC key, which allows a user to program and activate a sequence of keystrokes that are used frequently by a user.

A key 46 performs a backspace operation. A key 48 performs a character insertion operation and a key 50 performs an enter or new line operation. A key 60 sets and releases a Caps Lock function. A key 62 performs a Tab function. A key 64 performs a Back Tab function which is performed by pressing a Shift key and a Tab key of a standard PC keyboard. A key 66 performs an Escape (ESC) function. A key 68 sets and releases a Scroll Lock function. A key 70 sets and releases a Number Lock function. When Number Lock is set, any activation of multifunction keys 20 selects the digit which is associated with the key regardless of the angular direction of tilt on the multifunction key. A key 72 performs the function of an ‘Insert’ key of a standard PC keyboard. A key 74 performs the function of a ‘Delete’ key of a standard PC keyboard. A key 76 is a four-way key that performs the function of cursor keys of a standard PC keyboard. A key 78 is a four-way key that performs the functions of Page Up, Page Down, Home and End keys of a standard PC keyboard.

Input device 12 has a communication port 16 disposed thereon. Input device arrangement 10 also includes a base unit 24 which has a communication port 26. Base unit 24 is connected to processor 14 by a cable 30 which uses standard keyboard/mouse protocols such as serial PS/2 or USB. Processor 14 is typically a computer system or an interactive TV system. Communication port 16 and communication port 26 define a wireless communication link. Input device arrangement 10 is configured to wirelessly communicate keystrokes performed on input device 12 via the wireless communication link to processor 14. In a most preferred embodiment of the present invention, the wireless communication link is an infrared communication link. In an alternate embodiment of the present invention, the wireless communication link is either an RF or an ultrasound communication link. Input device 12 is stored in base unit 24 whenever input device 12 is not in use. Input device 12 has rechargeable batteries (not shown) which are recharged when input device 12 is stored in base unit 24. Base unit 24 has indicator lights, including a number lock indicator light 34, a caps lock indicator light 36, a scroll lock indicator light 38, a transmission indicator light 40, a receiving data indicator light 42 and a battery status indicator light 44. When input device 12 is stored in base unit 24, battery status indicator light 44, when lit, indicates that input device 12 is charging. When input device 12 is not stored in base unit 24, battery status indicator light 44 indicates, when lit, that the charge of rechargeable batteries of input device 12 is low. Input device 12 and base unit 24 are implemented using micro-controllers and standard digital and analog electronic circuitry that are well known those skilled in the art. It should be noted that base unit 24 can be integrally formed with a PC or Interactive television or other device.

Reference is now made to FIG. 3a and FIG. 3b. FIG. 3a is a front view of an interactive television input device 80 for use with base unit 24. FIG. 3b is a front view of an alternate embodiment of an interactive television input device 82 of the input device arrangement of FIG. 1. A plurality of keys 84 function in the same way as the same keys of input device 12. A plurality of keys 86 serves as an arrow-select navigator, which is used in most television remote controls. A two-way key 88 is for volume control and a two-way key 90 is for channel selection. A key set 92 contains four color-coded navigator keys (Red, Green, Yellow, and Blue). A plurality of other keys 94 perform other functions typically found with interactive television, such as ‘mute’, ‘display’, iDTV popular applications including TV-guide (EPG), ‘help’, ‘info’. Keys 94 include other hot keys for Internet services, such as service provider main menu functions, messaging/email and menu. A plurality of keys 96 is for device selection control (TV, STB, DVD, and AUD). A key 98 is a power button for the television.

By way of introduction, as described above, the layout, labeling and character assignment of the complete basic alphanumeric character are based on a standard telephone keypad. However, a standard telephone keypad includes two keys, namely key ‘7’ and key ‘9’, each of which has four letters plus a digit. However, since it is not desirable to have five functions per multifunction key, a letter from each of these two keys needs to be reassigned. It is convenient to reassign the letter ‘S’ and the letter ‘Z’. However, it should be noted that the other letters from key ‘7’ and key ‘9’ could be reassigned, for example the letters ‘P’, ‘Q’, ‘R’, ‘W’, ‘X’ and ‘Y’. Input device 80 is constructed in accordance with the most preferred embodiment of the present invention, whereby the layout of keys 84 is based on a standard telephone keypad, which has 12 keys including a ‘*’ key and a ‘#’ key. The layout of keys 84 on input device 80 is the same as the layout used on input device 12. Therefore, it is convenient to reassign the letter ‘S’ to the ‘*’ key and the letter ‘Z’ to the ‘#’ key. Input device 82 is constructed in accordance with an alternate embodiment of the present invention, whereby the layout of keys 84 is based on a modified telephone keypad, which has 10 keys. Therefore, on input device 82 the letters ‘S’ and ‘Z’ as well as many symbols including ‘*’ and ‘#’ are arranged differently. Therefore, it is convenient to assign the letter ‘S’ and the letter ‘Z’ to the digit ‘0’ key.

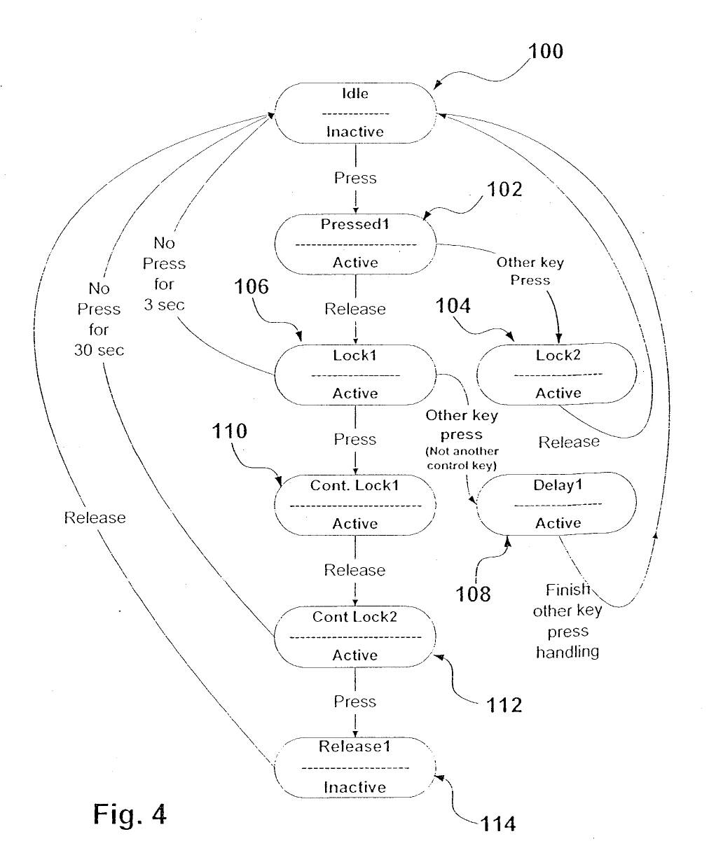

FIG. 4 is a flow chart showing a control key logic of control keys 32. By way of introduction, operation of control keys on a standard PC keyboard normally requires at least two fingers or typically two hands to activated a required function. The operation of control keys 32 of the present invention allow the user to operate input device arrangement 10 with one hand or two hands conveniently. Therefore, control keys 32 activation state is controlled by a dedicated controller. In addition, an LED is located under each of control keys 32 illuminating the key when the key is active. An active state means that the key is “virtually” pressed, in other words the computer system or interactive television system is given the impression the control key is depressed. The initial activation state of a control key is ‘Idle’ (box 100). If the user depresses the control key when the state of the control key is ‘Idle’, the status of the control key is set to an initial active state referred to as ‘Pressed1’ (box 102). If while the control key is still depressed another key is depressed, the status of the control key is changed to ‘Lock2’ (box 104) Whereby this other depressed key is assumed to be in conjunction with the control key which is depressed. Upon release of the control key the status of the control key returns to ‘Idle’ (box 100) and subsequently depressing another key is assume to be a start of a new key stroke and not in conjunction with the previously depressed and released control key. However if no other key is depressed while the control key is in state ‘Pressed 1° (box 102) then the release of the control key is not interpreted as a key release, instead the status of the control key is changed to ‘Lock1’ (box 106) and the system considers the control key as being depressed. An indication light is lit to alert the user that the control key is still considered depressed. When the controller detects a next keystroke by the user, the status of the control key is changed to ‘Delay1° (box 108). This next keystroke is assumed for at least a period of time, to be in conjunction with the control key that was previously released. However, if there is at delay between depressing and releasing the control key and depressing the next key, greater than a period of time, then the status of the control key returns to ‘Idle’ (box 100) and a next key stroke is not assumed to be in conjunction with the control key. In other words, there is typically a timeout, equal to a period of time, between status ‘Lock1’ (box 106) and status ‘Delay1° (box 108). This timeout typically has a duration of 3 seconds. In accordance with an alternate embodiment of the present invention, the timeout is set to be indefinite, in other words, there is no timeout. After a release of the next key, the controller deactivates the control key status, which is changed to ‘Idle’ (box 100). If the user wants to activate the control key for more than one additional key stroke, in other words to set a control key lock, the user can press the control key twice in sequence. Therefore, if the status of the control key is ‘Idle’ (box 100), and the control key is depressed and released, changing the status of the control key to ‘Lock1’ (box 106) and within at least a period of time, the control key is depressed again, changing the status of the control key to ‘Cont Lock1’ (box 110) and released again, changing the status of the control key to ‘Cont. Lock2’ (box 112), a control lock function is set for the control key. However, if there is a delay between the first depressing and releasing of the control key and depressing the control key, then the status of the control key returns to ‘Idle’ (box 100). In other words, there is typically a timeout, equal to a period of time, typically 3 seconds, between status ‘Lock1’ (box 106) and status ‘Cont. Lock1’ (box 110). In accordance with an alternate embodiment of the present invention, the timeout is set to be indefinite in other words, there is no timeout. The control lock function is released when the control key is subsequently depressed, changing the status of the control key to ‘Release1’ (box 114). When the control key is released the status of the control key returns to ‘Idle’ (box 100). Since the control key locking status activates a light indictor, typically an LED, it is preferable to return to the status of ‘Idle’ (box 100) if no input device activity is detected by the controller over a time out period, typically 30 seconds.

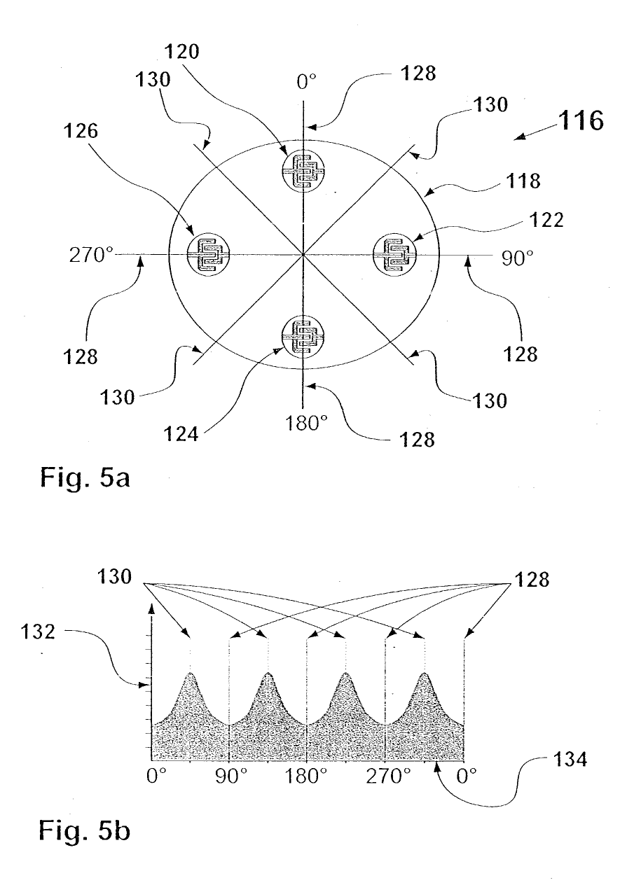

Reference is now made to FIG. 5a and FIG. 5b. FIG. 5a is a schematic plan view of a multifunction key 116 having a resisting arrangement for use with input device arrangement 10. FIG. 5b is a graph showing the behavior of the resisting arrangement of multifunction key 116. Multifunction key 116 includes a key body 118 and four make-and-break contacts 120, 122, 124, 126. Make-and-break contacts 120, 122, 124, 126 are typically micro switches connected to key body 118 or to a structure below key body 118 such that, when key body 118 is depressed, make-and-break contacts 120, 122, 124, 126 are selectively actuated by tilting key body 118 in a plurality of primary angular directions 128. Make-and-break contacts 120, 122, 124, 126 are alternatively contacts which are disposed on a circuit board that is below key body 118 and on key body 118 itself. Other embodiments of make-and-break contacts are know to those skilled in the art, for example dome contacts and switches. Therefore, when key body 118 is tilted in primary angular directions 128, only one of make-and-break contacts 120, 122, 124, 126 are selectively actuated. However, it is generally possible to tilt multifunction key 116 in a plurality of secondary angular directions 130 whereby at least two of make-and-break contacts 120, 122, 124, 126 are actuated. Therefore, to prevent data entry errors and to make data entry more efficient, it is desirable to discourage a user from titling multifunction key 116 in directions which are between the make-and-break contacts and to encourage the user to tilt multifunction key 116 in alignment with the make-and-break contacts. Therefore, multifunction key 116 includes a resisting arrangement which is configured to provide a greater resistance to a user titling key body 118 in secondary angular directions 130, than when a user tilts key body 118 in primary angular directions 128. FIG. 5b shows the force exerted (axis 132) by the resisting arrangement as a function of the angular direction of tilt (axis 134) of key body 118. Therefore. FIG. 5b shows that the resisting arrangement provides a maximum resistive force in secondary angular directions 130 and resisting arrangement provides a minimum resistive force in primary angular directions 128, thereby encouraging a user to depress key body 118 in primary angular directions 128.

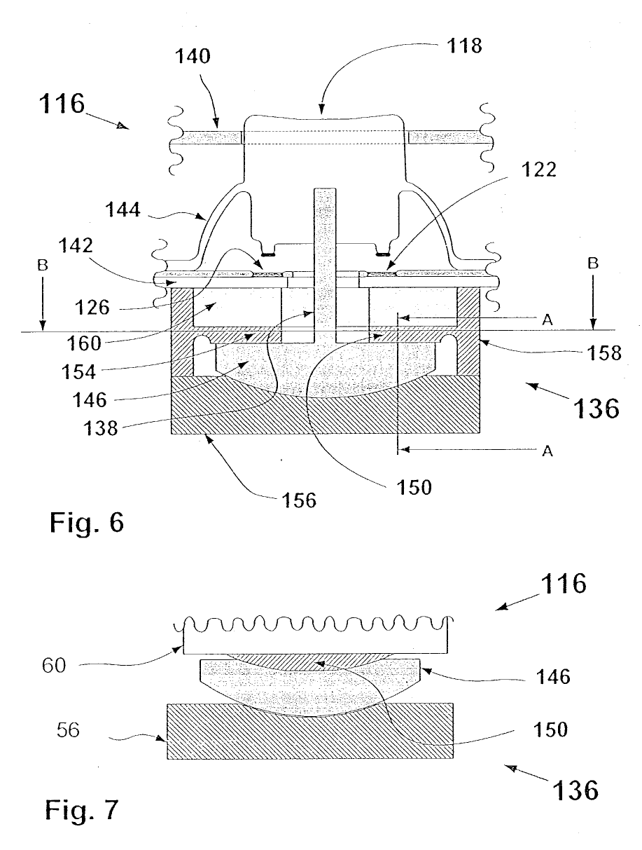

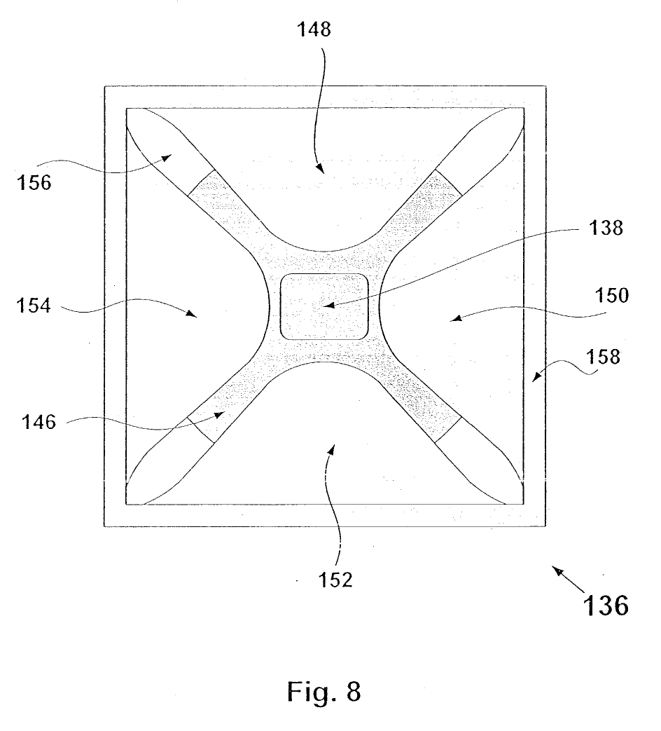

Reference is now made to FIG. 6. FIG. 7 and FIG. 8. FIG. 6 is a cross-sectional view of multifunction key 116, which includes a most preferred embodiment of a resisting arrangement 136 of the present invention. FIG. 7 is a cross-sectional view taken along line A-A of FIG. 6. FIG. 8 is a cross-sectional view taken along line B-B of FIG. 6. Key body 118 is disposed within a keyboard casing 140. Key body 118 is maintained in a neutral position above a circuit board 142 by a biasing member 144. Biasing member 144 is mechanically connected to circuit board 142 and key body 118. Make-and-break contacts 120, 122, 124, 126 are disposed on circuit board 142 and key body 118. Only make-and-break contact 122 and make-and-break contact 126 are shown in FIG. 6. Resisting arrangement 136 includes an elongated element 138 having two ends. One end of elongated element 138 is inserted into the lower side of key body 118. Resisting arrangement 136 also includes a lifting member 146. The other end of elongated element 138 is mechanically connected to the topside of lifting member 146. Lifting member projects laterally from the direction of elongation of elongated element 138. Lifting member 146 is typically a disk, having a convex bottom surface. Resisting arrangement 136 includes a rectangular base plate 156 and a surrounding wall 158. Surrounding wall 158 is typically formed from four rectangular plates. However, surrounding wall 158 is typically formed as a unitary element. Base plate 156 and surrounding wall 158 form a box. The top of surrounding wall 158 is connected to circuit board 142. The bottom of surrounding wall 158 is connected to base plate 156. Base plate 156 typically has a flat bottom surface. There is a concave portion on the top surface of base plate 156 in which the bottom surface of lifting member 146 rests. Resisting arrangement 136 includes four flaps 148, 150, 152, 154, which are disposed horizontally on lifting member 146. Each of flaps 148, 150, 152, 154 has at least one straight edge which is connected to surrounding wall 158. Flap 148 is disposed below make-and-break contact 120, flap 150 is disposed below make-and-break contact 122, flap 152 is disposed below make-and-break contact 124 and flap 154 is disposed below make-and-break contact 126. Each of flaps has 148, 150, 152, 154 a convex bottom surface which rests in a concave portion of the top of lifting member 146. Disposed between flaps 148, 150, 152, 154 and circuit board 142 is a block of resilient material 160, which resiliently supports flaps 148, 150, 152, 154, such that, when the user tilts key body 118 in secondary angular directions 130, a greater resistance is provided by flaps 148, 150, 152, 154 against lifting member 146 than when the user tilts key body 118 in primary angular directions 128. A greater resistance is provided by flaps 148, 150, 152, 154 when the user tilts key body 118 in secondary angular directions 130 as lifting member 146 lifts at least two of flaps 148, 150, 152, 154. However, when a user tilts key body 118 in primary angular directions 128, lifting member 146 only lifts one of flaps 148, 150, 152, 154, substantially. For example, if a user tilts key body 118 to actuate make-and-break contact 120, then lifting member 146 lifts flap 152. It is seen from FIG. 7 that the convex bottom surface of flap 150 allows lifting member 146 to rotate around flap 150 when lifting member 146 is lifting flap 152. Therefore, flap 150 provides minimal resistance against the movement of lifting member 146 in this example. Similarly, in this example, lifting member 146 rotates around flap 150. However, if for example, key body 118 is tilted in an angular direction which is between make-and-break contact 120 and make-and-break contact 122, lifting member 146 lifts flap 152 and flap 154. Additionally, due to the convex bottom surface of flaps 152, 154 and the concave portions of the top of lifting member 146, flap 152 needs to be moved higher by lifting member 146 than flap 152 is moved if key body 118 is tilted in alignment with make-and-break contact 120; and flap 154 needs to be moved higher by lifting member 146 than flap 154 is moved if key body 118 is titled in alignment with make-and-break contact 122. In other words the convex bottom surface of flaps 148, 150, 152, 154 and the concave portions of the top of lifting member 146 additionally provide a greater resistance against a user tilting key body 118 in secondary angular directions 130 than tilting key body 118 in primary angular directions 128. It should be noted that key body 118, elongated element 138 and lifting member 146 are typically formed as a unitary element.

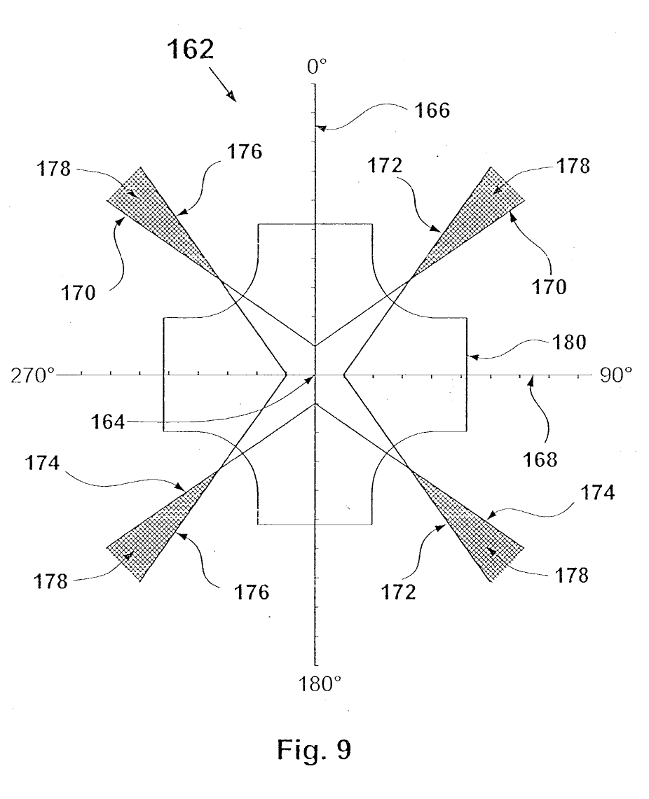

Reference is now made to FIG. 9, which is a graph 162 showing the relationship between the activity regions of make-and-break contacts 120, 122. 124, 126 and the angular directions of tilt of multifunction key 116. The distance from an origin 164 of graph 162 represents the force exerted on key body 118. Primary angular directions 128 are shown on graph 162 by an axis 166 and an axis 168. An area above a line 170 represents the active region of make-and-break contact 120. An area to the right of a line 172 represents the active region of make-and-break contact 122. An area below a line 174 represents the active region of make-and-break contact 124. An area to the left of a line 176 represents the active region of make-and-break contact 126. It can be see that four shaded areas 178 represent an overlap of active regions of make-and-break contacts 120, 122, 124, 126. Therefore, if the movement of key body 118 is restricted to within a region 180 such that key body 118 cannot be tilted to shaded areas 178, then make-and-break contacts 120, 122, 124, 126 can only be activated one at a time.

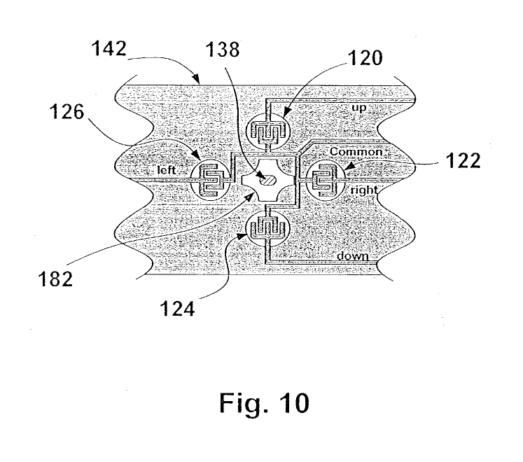

Reference is now made to FIG. 10, which is a plan view of a template 182 formed within circuit board 142 of multifunction key 116. In accordance with a preferred embodiment of the present invention, resisting arrangement 136 includes elongated element 138 which guides the tilting of key body 118 within template 182 such that the movement of keys body 118 is restricted to within region 180 (FIG. 9). Therefore, when the user tilts key body 118 in secondary angular directions 130, a greater inhibition is provided by template 182 against elongated element 138 than when the user tilts key body 118 in primary angular directions 128. In this embodiment of resisting arrangement 136, the other components of resisting arrangement 136 described with respect to FIGS. 6, 7 and 8 are not required.

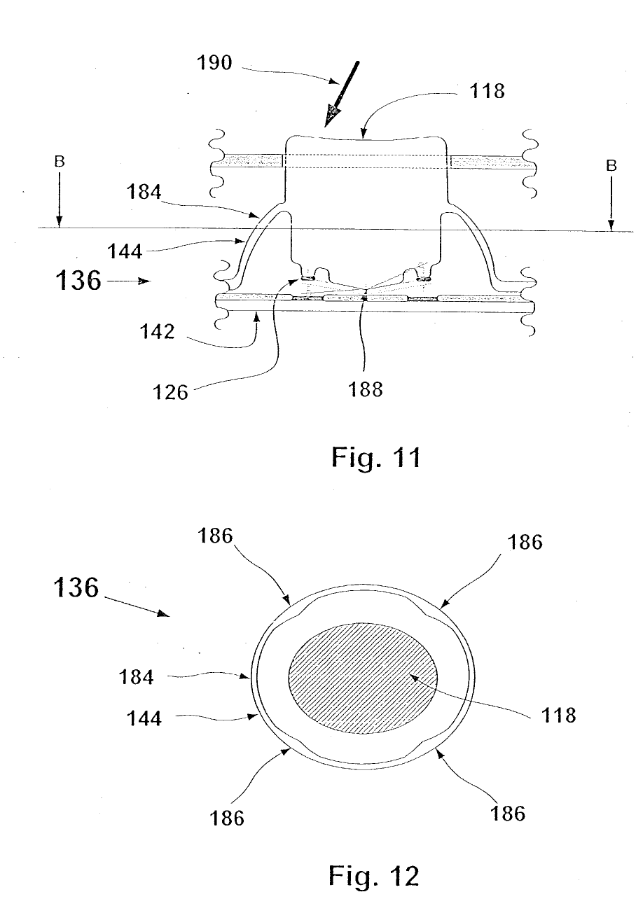

Reference is now made to FIG. 11 and FIG. 12. FIG. 11 is a cross-sectional view multifunction key 116, having an alternate resisting arrangement 136. FIG. 12 is a cross-sectional view taken along line B-B of FIG. 11. In accordance with a preferred embodiment of the present invention, resisting arrangement 136 includes a resilient support structure 184, which is configured to at least partially support key body 118, such that, when the user tilts key body 118 in secondary angular directions 130, a greater resistance is provided by resilient support structure 184 against key body 118 than when the user tilts key body 118 in primary angular directions 128. Resilient support structure 184 is typically implemented as at least part of biasing member 144, whereby biasing member 144 has a plurality of thicker regions 186, which provide a greater resistance against tilting key body 118 in secondary angular directions 130. In this embodiment of resisting arrangement 136, the other components of resisting arrangement 136 described with respect to FIGS. 6, 7, 8, 9 and 10 are not required. It should be noted that resilient support structure 184 could be implemented separately from biasing member 144. It should also be noted that resilient support structure 184 can be implemented in other forms including a rectangular resilient block which is disposed between key body 118 and circuit board 142, thereby providing greater resistance to tilting key body 118 in secondary angular directions 130 than tilting key body 118 in primary angular directions 128. It will be apparent to those skilled in the art that biasing member 144 can be adapted depending on the design and shape of key body 118.

It should be noted that when key body 118 is tilted, a central point 188 on the lower surface of key body 118 moves laterally with respect to circuit board 142. For example, when key body 118 is tilted in a direction 190, lateral movement of central point 188 may cause mismatching of make-and-break contact 126 on key body 118 with make-and-break contact 126 on circuit board 142. Therefore, it is preferable to limit the lateral movement of central point 188.

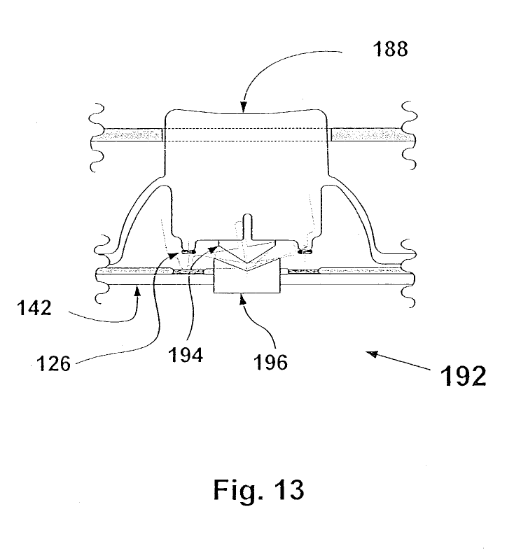

FIG. 13 is a centralization mechanism 192 for use multifunction key 116 key of FIG. 11. Centralization mechanism 192 includes a male cone 194 which is connected to the lower surface of key body 118. Centralization mechanism 192 also includes a female cone 196 which is connected to circuit board 142. Male cone 194 rests within female cone 196 and prevents the problem associated with lateral movement of key body 118 described with reference to FIG. 12. The size of male cone 194 and the size of female cone 196 are chosen such that key body 118 can be tilted in order to actuate make-and-break contacts 120, 122, 124, 126. In accordance with an alternate embodiment of the present invention, male cone 194 is connected to circuit board 142 and female cone 196 is connected to key body 118.

It still be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description.

What is claimed is:

1. A system comprising a processor and an input device, wherein:
(a) said input device has a first communication port disposed thereon, said first communication port being configured to wirelessly communicate keystrokes performed on said input device to said processor;
(b) said input device is configured for being held and operated with one hand;
(c) said input device has a plurality of keypads, one of said keypads being a primary keypad located centrally on said input device, said primary keypad having a complete basic alphanumeric character set and a plurality of symbols, said primary keypad having at least ten multifunction keys arranged in a grid of three columns by four rows, each of said multifunction keys being configured for single-touch selection of exactly four functions depending on a direction of force thereon, one of said four functions being uniquely selected from group consisting of a digit in the range of 0 to 9 and a “*” symbol and a “#” symbol, at least one of said symbols is uniquely associated with each of said multifunction keys; said primary keypad being visually distinguished from other of said keypads by at least one of a key shape, a key color, a key labeling font, a key labeling color and a key labeling font size; and
(d) said input device has a secondary keypad including at least three control keys, each of said control keys being configured to perform a function in conjunction with at least one other key, one of said control keys being a shift control key configured to select a capital letter from said primary keypad, one of said control keys being a symbol control key configured to select one of said symbols from said primary, keypad.

2. The system of claim 1, wherein said secondary keypad includes a row of keys including a character insertion function key, an enter function key and a backspace function key.

3. The system of claim 1, wherein said control keys include an auxiliary control key configured to perform a plurality of Windows OS functions and a plurality of multimedia extension functions in conjunction with said primary key pad.

4. The system of claim 1, wherein said control keys include a macro key configured to allows a user to program and activate a sequence of keystrokes that are used frequently by a user.

5. The system of claim 1, wherein said input device includes a volume control key, a channel selection key, at least one interactive television navigator key, at least one device selection key and at least one Internet service key.

6. The system of claim 1, wherein said input device includes at least one quick application launcher key.

7. The system of claim 1, wherein said input device includes at least one of a pointing device and a joystick control.

8. The system of claim 1, wherein:
(a) said input device has a casing which has a top surface and a bottom surface;
(b) said top surface has a long dimension, a width measurement perpendicular to said long dimension and a central region;
(c) said width measurement has a local minimum value within said central region; and
(d) said bottom surface has a convex portion.

9. The system of claim 1, further comprising a base unit having a second communication port, wherein:
(a) said base unit is connected to said processor;
(b) said first communication port and said second communication port define a wireless communication link; and
(c) at least one of said input device and said base unit are configured to wirelessly communicate keystrokes performed on said input device via said wireless communication link to said processor.

10. The system of claim 9, wherein said wireless communication link is an infrared communication link.

11. The system of claim 1, wherein said control keys are disposed near a periphery of said input device.

12. The system of claim 1, wherein at least one of said multifunction keys includes:
(a) a key body;
(b) a set of at least three make-and-break contacts disposed below said key body; said key body being tilted in a plurality of primary angular directions in order to selectively actuate only one of said set; and
(c) a resisting arrangement configured to provide a greater resistance to a user tilting said key body in one of a plurality of secondary angular directions compared to said user tilting said key body in one of said primary angular directions.

13. The system of claim 12, wherein:
(a) said key body has a lower side;
(b) said resisting arrangement includes an elongated element having a first end and a second end, said first end being disposed on said lower side; and
(c) said resisting arrangement includes a lifting member which is disposed on said second end, said lifting member projecting laterally from said elongated element.

14. The system of claim 13, wherein said resisting arrangement includes at least three flaps, wherein said flaps are disposed on said lifting member and are resiliently supported, such that, when said user tilts said key body in one of said secondary angular directions, a greater resistance is provided by said flaps against said lifting member than when said user tilts said key body in one of said primary angular directions.

15. The system of claim 14, wherein at least one of said flaps has a bottom surface, said bottom surface including a convex portion.

16. The system of claim 13, wherein said resisting arrangement includes at least three flaps, wherein said flaps are disposed on said lifting member and are resiliently supported, such that, when said user tilts said key body in one of said secondary angular directions, said lifting member lifts at least two of said flaps, and when said user tilts said key body in one of said primary angular directions, said lifting member only lifts one of said flaps substantially.

17. The system of claim 16, wherein at least one of said flaps has a bottom surface, said bottom surface including a convex portion.

18. The system of claim 13, wherein said key body and said elongated element are formed as a unitary member.

19. The system of claim 13, herein said elongated element and said lifting member are formed as a unitary member.

20. The system of claim 12, wherein said resisting arrangement includes a resilient support structure, which is configured to at least partially support said key body, such that, when said user tilts said key body in one of said secondary angular directions, a greater resistance is provided by said resilient support structure against said key body than when said user tilts said key body in one of said primary angular directions.

21. The system of claim 1, wherein at least one of said multifunction keys includes:
(a) a key body having a lower side;
(b) a set of at least three make-and-break contacts disposed below said key body; said key body being titled in a plurality of primary angular directions in order to selectively actuate only one of said set;
(c) an elongated element having a first end and a second end, said first end being disposed on said lower side; and
(d) a template which is rigidly supported, said template being formed, such that, when a user tilts said key body in one of a plurality of secondary angular directions, a greater inhibition is provided by said template against said elongated element than when said user tilts said key body in one of said primary angular directions.

22. The system of claim 1, wherein at least one of said input device and said processor is configured such that:
(a) when one of said control keys is depressed and released, a next key stroke is assumed, for at least a period of time, to be in conjunction with said one control key that was previously released; and
(b) a first key that is depressed while said one control key is depressed is assumed to be in conjunction with said one control key; and
(c) after a release of said one control key and said first key, a depression of a second key is assumed to be a start of a new keystroke.

23. The system of claim 22, wherein at least one of said input device and said processor is further configured such that when said one control key is depressed and released and within at least a period of time, said one control key is depressed and released again, a control lock function is set for said one control key.

24. The system of claim 1, wherein at least one of said input device and said processor is configured such that, when one of said control keys is depressed and released and within at least a period of time, said one control key is depressed and released again, a control lock function is set for said one control key.

25. The system of claim 24, wherein at least one of said input device and said processor is further configured such that, said control lock function is released when said one control key is subsequently one of, depressed and depressed and released.

26. The system of claim 1, wherein:
(a) for each of eight of said ten multifunction keys, one of said four functions is uniquely associated with a digit in the range 2 to 9;
(b) for each of said eight multifunction keys, each of three of said four functions is uniquely associated with a letter; and
(c) for one of said ten multifunction keys, one of said four functions is associated with a digit zero, one of said four functions is associated with a letter from a group consisting of a letter ‘P’ and a letter ‘Q’ and a letter ‘R’ and a letter ‘S’, one of said four functions is associated with a letter from a group consisting of a letter ‘W’ and a letter ‘X’ and a letter ‘Y’ and a letter ‘Z’.

27. The system of claim 1, wherein:
(a) for each of eight of said ten multifunction keys one of said four functions is uniquely associated with a digit in the range 2 to 9;
(b) for each of said eight multifunction keys, each of three of said four functions is uniquely associated with a letter;
(c) for one of said ten multifunction keys, one of said four functions is associated with a symbol “*” one of said four functions is associated with a letter front a group consisting of a letter ‘P’ and a letter ‘Q’ and a letter ‘R’ and a letter ‘S’; and
(d) for one of said ten multifunction keys, one of said four functions is associated with a symbol “#”, one of said four functions is associated with a letter from a group consisting of a letter ‘W’ and a letter ‘X’ and a letter ‘Y’ and a letter ‘Z’.

28. A multifunction key, comprising:
(a) a key body;
(b) a set of at least three make-and-break contacts disposed below said key body; said key body being titled in a plurality of primary angular directions in order to selectively actuate only one of said set; and
(c) a resisting arrangement configured to provide a greater resistance to a user tilting said key body in one of a plurality of secondary angular directions compared to said user tilting said key body in one of said primary angular directions.

29. The multifunction key of claim 28, wherein:
(a) said key body has a lower side;
(b) said resisting arrangement includes an elongated element having a first end and a second end, said first end being disposed on said lower side; and
(c) said resisting arrangement includes a lifting member which is disposed on said second end, said lifting member projecting laterally from said elongated element.

30. The multifunction key of claim 29, wherein said resisting arrangement includes at least three flaps, wherein said flaps are disposed on said lifting member and are resiliently supported, such that, when said user tilts said key body in one of said secondary angular directions, a greater resistance is provided by said flaps against said lifting member than when said user tilts said key body in one of said primary angular directions.

31. The multifunction key of claim 30, wherein at least one of said flaps has a bottom surface, said bottom surface including a convex portion.

32. The multifunction key of claim 29, wherein said resisting arrangement includes at least three flaps, wherein said flaps are disposed on said lifting member and are resiliently supported, such that, when said user tilts said key body in one of said secondary angular directions, said lifting member lifts at least two of said flaps, and when said user tilts said key body in one of said primary angular directions, said lifting member only lifts one of said flaps substantially.

33. The multifunction key of claim 32, wherein at least one of said flaps has a bottom surface, said bottom surface including a convex portion.

34. The multifunction key of claim 29, wherein said key body and said elongated element are formed as a unitary member.

35. The multifunction key of claim 29, wherein said elongated element and said lifting member are formed as a unitary member.

36. The multifunction key of claim 28, wherein said resisting arrangement includes a resilient support structure, which is configured to at least partially support said key body, such that, when said user tilts said key body in one of said secondary angular directions, a greater resistance is provided by said resilient support structure against said key body than when said user tilts said key body in one of said primary angular directions.

37. A multifunction key, comprising:
(a) a key body having a lower side;
(b) a set of at least three make-and-break contacts disposed below said key body; said key body being titled in a plurality of primary angular directions in order to selectively actuate only one of said set;
(c) an elongated element having a first end and a second end, said first end being disposed on said lower side; and
(d) a template which is rigidly supported, said template being formed, such that, when a user tilts said key body in one of a plurality of secondary angular directions, a greater inhibition is provided by said template against said elongated element than when said user tilts said key body in one of said primary angular directions.

38. A system, comprising:
(a) a processor; and
(b) a input device having a plurality of keys, said input device being associated with said processor, at least one of said keys being a control key, at least one of said input device and said processor being configured such that:
(i) when said control key is depressed and released, a next keystroke is assumed, for at least a period of time, to be in conjunction with said control key that was previously released;
(ii) a first key that is depressed while said control key is depressed is assumed to be in conjunction with said control key; and
(iii) after a release of said control key and said first key, a depression of a second key is assumed to be a start of a new keystroke.

39. The system of claim 38, wherein at least one of said input device and said processor is further configured such that when said control key is depressed and released and within at least a period of time, said control key is depressed and released again, a control lock function is set for said control key.

40. The system of claim 38, wherein:
(a) said input device is configured for being held and operated with one hand; and
(b) said control key is disposed near a periphery of said input device.

41. A system, comprising:
(a) a processor; and
(b) a input device having a plurality of keys, said input device being associated with said processor, at least one of said keys being a control key, at least one of said input device and said processor being configured such that when said control key is depressed and released and within at least a period of time, said control key is depressed and released again, a control lock function is set for said control key.

42. The system of claim 41, wherein at least one of said input device and said processor is further configured such that, said control lock function is released when said control key is subsequently one of, depressed and depressed and released.

43. The system of claim 41, wherein:
(a) said input device is configured for being held and operated with one hand; and
(b) said control key is disposed near a periphery of said input device.

44. A input device comprising:
(a) at least eight multifunction keys, each of said multifunction keys being configured for single-touch selection of one of four functions, one of said four functions being uniquely associated with a digit in the range 2 to 9, each of three of said four functions being uniquely associated with a letter: and
(b) a multifunction key configured for single-touch selection of one of at least three functions, wherein:
(i) one of said at least three functions is associated with a digit zero;
(ii) one of said at least three functions is associated with a letter from a group consisting of a letter ‘P’ and a letter ‘Q’ and a letter ‘R’ and a letter ‘S’; and
(iii) one of said at least three functions is associated with a letter from a group consisting of a letter ‘W’ and a letter ‘X’ and a letter ‘Y’ and a letter ‘Z’.

45. An input device comprising:
(a) at least eight multifunction keys, each of said multifunction keys being configured for single-touch selection of one of four functions, one of said four functions being uniquely associated with a digit in the range 2 to 9, each of three of said four functions being uniquely associated with a letter;
(b) a multifunction key configured for single-touch selection of one of at least two functions, wherein:
(i) one of said at least two functions is associated with a symbol ‘*’; and
(ii) one of said at least two functions is associated with a letter from a group consisting of a letter ‘P’ and a letter ‘Q’ and a letter ‘R’ and a letter ‘S’; and
(b) a multifunction key configured for single-touch selection of one of at least two functions, wherein:
(i) one of said at least two functions is associated with a symbol ‘#’; and
(ii) one of said at least two functions is associated with a letter from a group consisting of a letter ‘W’ and a letter ‘X’ and a letter ‘Y’ and a letter ‘Z’.
